(19) United States
(12) Patent Application Publication
(10) Pub. No.: US 2026/0321201 A1
(43) Pub. Date: Oct. 15, 2026

(54) APPARATUS AND METHOD FOR DRIVING DISPLAY PANEL

(71) Applicant: LX SEMICON CO., LTD., Daejeon (KR)

(72) Inventors: Seok Hoo KIM, Daejeon (KR); Jinwoo Park, Daejeon (KR)

(73) Assignee: LX SEMICON CO., LTD., Daejeon (KR)

(21) Appl. No.: 19/639,336

(22) Filed: Apr. 6, 2026

(30) Foreign Application Priority Data
Apr. 10, 2025 (KR) 10-2025-0047105

(51) Int. Cl. G09G 3/3225; G09G 3/20

(52) U.S. Cl. CPC G09G 3/3225; G09G 3/2096; G09G 2320/045; G09G 2330/026

(57) ABSTRACT

An OLED display panel driving apparatus includes a storage device in which compensation data for compensating sub-pixels is stored; and a timing controller configured to load the compensation data from the storage device and to compensate image data, wherein the timing controller includes: a first data loading unit configured to load first data which is a portion of the compensation data; a second data loading unit configured to load second data which is a remaining portion of the compensation data; and a data compensating unit configured to compensate the image data using the first data during a first period and to compensate the image data using the first and second data during a second period, and wherein the second data loading unit is configured to load the second data while image data compensated with the first data is being output.

### CROSS-REFERENCE TO RELATED APPLICATION

This application claims the priority of Korean Patent Application No. 10-2025-0047105 filed on Apr. 10, 2025, which is hereby incorporated by reference in its entirety.

### BACKGROUND

### Field of the Disclosure

The present disclosure relates to a display panel driving apparatus, and more particularly, to an organic light emitting diode (OLED) display panel driving apparatus.

### Description of the Background

Organic light emitting diode (hereinafter referred to as “OLED”) display devices include self-emissive OLEDs, and have advantages such as fast response speed, high luminous efficiency, high luminance, and a wide viewing angle.

An OLED, which is a self-emissive element, includes an anode electrode, a cathode electrode, and an organic compound layer formed therebetween, where the organic compound layer includes a hole injection layer (HIL), a hole transport layer (HTL), an emission layer (EML), an electron transport layer (ETL), and an electron injection layer (EIL). When a supply voltage is applied to the anode and cathode electrodes, holes having passed through the HTL and electrons having passed through the ETL move to the EML to form excitons, whereby the EML emits visible light.

OLED display devices arrange sub-pixels, each including an OLED and a driving thin film transistor (TFT), in a matrix, and controls the luminance of an input image implemented through the sub-pixels according to the gradation of image data. The driving transistor controls a pixel current flowing through the OLED according to a voltage applied between its gate electrode and source electrode. The amount of light emitted from the OLED is determined by the pixel current and the luminance of the image data is determined according to the amount of light emitted from the OLED.

OLED display devices suffer from a luminance non-uniformity problem across sub-pixels due to various causes. For instance, process variations during the fabrication of the transistor substrate can cause the characteristics such as a threshold voltage (Vth) and mobility (k) of the driving transistor to vary between sub-pixels. Consequently, even when an identical data voltage (VDATA) is applied to each sub-pixel, the resulting current through each OLEDs differs, leading to non-uniform luminance levels.

In another example, as driving time elapses, the driving transistor and OLEDs undergo degradation, leading to shifts in their driving characteristics. Consequently, even when the identical data voltage (VDATA) is applied to each sub-pixel, variations in current flowing through the OLEDs may occur, leading to non-uniform luminance levels.

To address these issues, OLED display devices pre-store compensation data in a storage device such as a flash memory. When the power is turned on, OLED display devices load the compensation data from the flash memory to compensate the image data using the loaded compensation data, thereby achieving uniform luminance.

To prevent the loading operation of the compensation data and the compensation operation of the image data being perceived by a user, OLED display devices have to complete the loading and compensation operations during a short booting time it takes from when the power is turned on until an image is displayed on a display panel.

However, as shown in FIG. 1, with the increasing resolution of OLED display devices, such as Ultra High Definition (UHD), the volume of compensation data per sub-pixel also increases. Consequently, the time required to load the compensation data inevitably increases, which may lead to a prolonged booting time of OLED display devices or in a failure to render a normal image within a predetermined booting period.

### SUMMARY

The present disclosure provides an apparatus and method for driving an OLED display panel capable of reducing the booting time of an OLED display device by performing compensation after loading only a predetermined portion of the compensation data among the overall compensation data.

The present disclosure provides an apparatus and method for driving an OLED display panel capable of preventing deterioration in image quality, which may occur due to compensation of image data using only partial compensation data, from being perceived by a user.

According to an aspect of the present disclosure, there is provided an OLED display panel driving apparatus comprising: a storage device in which compensation data for compensating sub-pixels included in an OLED display panel is stored; and a timing controller configured to load the compensation data from the storage device and to compensate image data to be output through the sub-pixels, wherein the timing controller includes: a first data loading unit configured to load, from the storage device, first data which is a portion of the compensation data, a second data loading unit configured to load, from the storage device, second data which is a remaining portion of the compensation data; and a data compensating unit configured to compensate the image data using the first data during a first period including n frames, and to compensate the image data using the first and second data during a second period after the first period, wherein the second data loading unit is configured to load the second data while image data compensated with the first data is being output.

According to another aspect of the present disclosure, there is provided a method for driving an OLED display panel, the method comprising: loading, from a storage device in which compensation data for compensating sub-pixels included in the OLED display panel is stored, first data which is a portion of the compensation data; compensating and outputting image data using the first data during a first period including n frames; loading, from the storage device, second data which is a remaining portion of the compensation data while image data compensated with the first data is being output; and compensating and outputting the image data using the first and second data during a second period after the first period.

### BRIEF DESCRIPTION OF THE DRAWINGS

The accompanying drawings, which are included to provide a further understanding of the disclosure and are incorporated in and constitute a part of this application, illustrate aspects of the disclosure and together with the description serve to explain the principle of the disclosure.

In the drawings:

FIG. 1 conceptually illustrates an increase in loading time of compensation data according to an increase in resolution of an OLED display device;

FIG. 2 illustrates a configuration of an OLED display device including an OLED display panel driving apparatus according to an aspect of the present disclosure;

FIG. 3 is a block diagram schematically showing a configuration of a timing controller illustrated in FIG. 2;

FIG. 4 illustrates an example in which first data and second data loaded from a storage device by the timing controller are stored;

FIG. 5 conceptually illustrates the reduction in initial display time achieved by compensation and display of the image data according to the present disclosure, compared to that of the conventional method; and

FIG. 6 is a flowchart illustrating a method for driving an OLED display panel according to an aspect of the present disclosure.

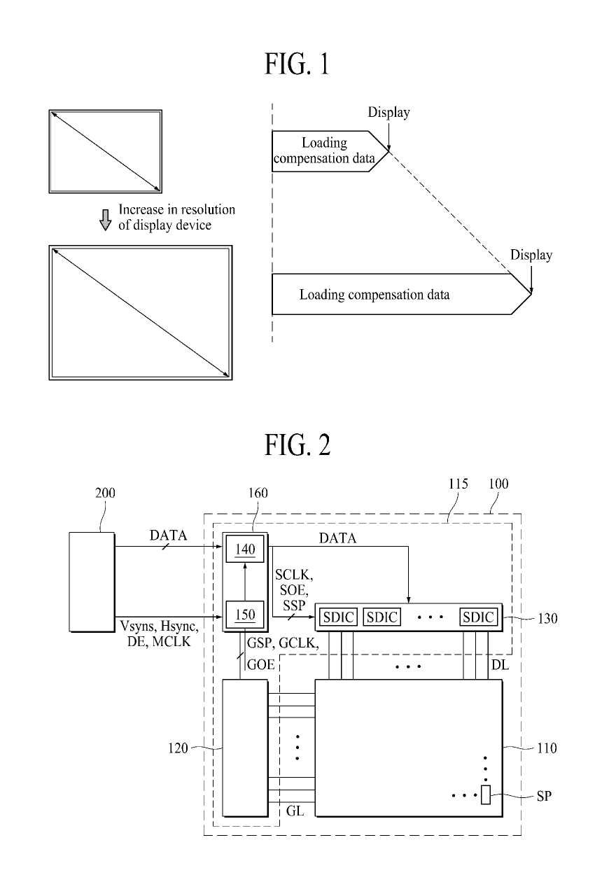

### DETAILED DESCRIPTION

Like reference numerals refer to like elements throughout. In the following description, when the detailed description of the relevant known function or configuration is determined to unnecessarily obscure the important point of the present disclosure, the detailed description will be omitted.

Advantages and features of the present disclosure, and implementation methods thereof will be clarified through following exemplary aspects described with reference to the accompanying drawings. The present disclosure may, however, be embodied in different forms and should not be construed as limited to the exemplary aspects set forth herein. Rather, these exemplary aspects are provided so that this disclosure will be thorough and complete, and will fully convey the scope of the present disclosure to those skilled in the art. Further, the present disclosure is only defined by scopes of claims.

A shape, a size, a ratio, an angle, and a number disclosed in the drawings for describing exemplary aspects of the present disclosure are merely an example, and thus, the present disclosure is not limited to the illustrated details.

In a case where “include,” “have,” “comprise,” “contain,” “constitute,” “make up of,” “formed of,” and “consist of” described in the present specification are used, another part can be added unless ‘only~’ is used. The terms of a singular form can include plural forms unless referred to the contrary.

In construing an element, the element is construed as including an error range although there is no explicit description.

In describing a position relationship, for example, when a position relation between two parts is described as “on”, “above”, “over”, “below”, “under”, “beside”, “beneath”, “near”, “close to, ” “adjacent to”, “on a side of”, “next”, one or more other parts may be disposed between the two parts unless ‘just’ or ‘direct’ is used.

It will be understood that, although the terms “first”, “second” etc. can be used herein to describe various elements, these elements should not be limited by these terms. These terms are only used to distinguish one element from another. Accordingly, a first element mentioned hereinafter could be termed a second element without departing from the scope of the present disclosure.

The term “at least one” should be understood as including any and all combinations of one or more of the associated listed items. For example, the meaning of “at least one of a first item, a second item, and a third item” denotes each of the first item, the second item, and the third item as well as the combination of all items proposed from two or more of the first item, the second item, and the third item.

Features of various exemplary aspects of the present disclosure can be partially or overall coupled to or combined with each other and can be variously inter-operated or combined with each other and driven technically as those skilled in the art can sufficiently understand. The exemplary aspects of the present disclosure can be carried out independently from each other, or can be carried out together in co-dependent relationship.

Hereinafter, example aspects of the present disclosure will be described in detail with reference to the accompanying drawings.

FIG. 2 illustrates a configuration of an OLED display device including an OLED display panel driving apparatus according to an aspect of the present disclosure.

The OLED display device 100 illustrated in FIG. 2 is an electronic device including the OLED display panel driving apparatus according to the present disclosure and may be, for example, various types of display devices that use a voltage of a battery or an external power supply as an operating voltage. In one aspect, the OLED display device 100 may be an in-vehicle display device mounted in an automobile.

Referring to FIG. 2, the OLED display device 100 according to the present disclosure includes an OLED display panel 110 in which a plurality of gate lines GL and a plurality of data lines DL are connected and a plurality of sub-pixels SP are arranged in a matrix form, and the OLED display panel driving apparatus 115 for driving the OLED display panel 110. The OLED display panel driving apparatus 115 includes a gate driving circuit 120 for driving the plurality of gate lines GL, a data driving circuit 130 for supplying data voltages through the plurality of data lines DL, and a display panel control device 160 for controlling the gate driving circuit 120 and the data driving circuit 130.

In particular, as illustrated in FIG. 2, the display panel control device 160 according to the present disclosure may include a timing controller 140 and a storage device 150.

The OLED display panel 110 displays images based on scan signals delivered from the gate driving circuit 120 through the plurality of gate lines GL and data voltages delivered from the data driving circuit 130 through the plurality of data lines DL.

In one aspect, the OLED display panel 110 may be implemented as a top emission type, a bottom emission type, or a dual emission type, and the like.

The OLED display panel 110 may have a plurality of pixels arranged in a matrix form. Each pixel may include sub-pixels SPs of different colors, for example, a white sub-pixel, a red sub-pixel, a green sub-pixel, and a blue sub-pixel. Each sub-pixel SP may be defined by the plurality of data lines DL and the plurality of gate lines GL.

One sub-pixel SP may include a thin film transistor (TFT) provided in a region where one data line DL and one gate line GL intersect, an organic light emitting diode, and a storage capacitor electrically connected to the organic light emitting diode to maintain a voltage. An image may be displayed by controlling a current flowing through the organic light emitting diode disposed in each sub-pixel SP.

The gate driving circuit 120 is controlled by the timing controller 140. The gate driving circuit 120 sequentially outputs scan signals to the plurality of gate lines GL arranged in the OLED display panel 110 to control driving timings for the plurality of sub-pixels SP.

In one aspect, the gate driving circuit 120 may include at least one gate driver integrated circuit (GDIC) and may be disposed on one side or both sides of the OLED display panel 110 depending on a driving scheme. In another aspect, the gate driving circuit 120 may be implemented as a gate in panel (GIP) type, in which the gate driving circuit 120 is embedded in a bezel region of the OLED display panel 110.

One or more gate driver integrated circuits GDICs included in the gate driving circuit 120 may each be mounted on a gate film, and one side of the gate film may be electrically connected to the OLED display panel 110. In addition, wirings for electrically connecting the gate driver integrated circuit GDIC to the OLED display panel 110 may be disposed on an upper portion of the gate film.

The data driving circuit 130 receives image data DATA from the timing controller 140 and converts the received image data DATA into analog data voltages. Then, the data driving circuit 130 outputs the data voltages to the respective data lines DL in synchronization with timings at which scan signals are applied through the gate lines GL, so that each sub-pixel SP connected to the data lines DL displays an emission signal having a brightness corresponding to the data voltage.

The data driving circuit 130 may include at least one source driver integrated circuit (SDIC). The SDIC may be connected to bonding pads of the OLED display panel 110 by a tape automated bonding (TAB) method or a chip on glass (COG) method, or may be directly mounted on the OLED display panel 110.

In one aspect, each SDIC may be integrated and disposed on the OLED display panel 110. Each SDIC may also be implemented in a chip on film (COF) manner, and in this case, each SDIC is mounted on a circuit film and electrically connected to the data lines DL of the OLED display panel 110 through the circuit film.

One or more SDICs included in the data driving circuit 130 may each be mounted on a source film, and one side of the source film may be electrically connected to the OLED display panel 110. In addition, wirings for electrically connecting the SDICs to the OLED display panel 110 may be disposed on an upper portion of the source film.

The timing controller 140 supplies control signals to the gate driving circuit 120 and the data driving circuit 130 and controls operations of the gate driving circuit 120 and the data driving circuit 130. That is, the timing controller 140 controls the gate driving circuit 120 to output scan signals according to timings implemented in the each frame, and controls the data driving circuit 130 to output data voltages corresponding to image data DATA to the data lines DL by delivering image data DATA received from the outside to the data driving circuit 130.

At this time, the timing controller 140 may receive timing signals including a vertical sync signal Vsync, a horizontal sync signal Hsync, a data enable signal DE, and a main clock MCLK, and the like, together with the image data DATA, from an external host system 200.

The host system 200 may be any one of a television (TV) system, a set-top box, a navigation system, a personal computer (PC), a home theater system, a mobile device, and a wearable device.

Accordingly, the timing controller 140 generates control signals using the timing signals received from the host system 200 and delivers the control signals to the gate driving circuit 120 and the data driving circuit 130.

For example, in order to control the gate driving circuit 120, the timing controller 140 outputs, to the gate driving circuit 120, gate control signals including a gate start pulse GSP, a gate clock GCLK, a gate output enable signal GOE, and the like.

The gate start pulse GSP controls timings at which at least one GDIC constituting the gate driving circuit 120 starts operating. The gate clock GCLK is a clock signal commonly input to the at least one GDIC and controls shift timings of scan signals. The gate output enable signal GOE specifies timing information of at least one GDIC.

In addition, in order to control the data driving circuit 130, the timing controller 140 outputs, to the data driving circuit 130, data control signals including a source start pulse SSP, a source sampling clock SCLK, a source output enable signal SOE, and the like. The SSP controls timings at which at least one SDIC constituting the data driving circuit 130 starts data sampling. The SCLK is a clock signal that controls timings at which data is sampled by at least one SDIC. The SOE controls output timings of at least one SDIC.

Further, the timing controller 140 loads compensation data from the storage device 150 and compensates image data DATA to be output through each sub-pixel SP using the loaded compensation data.

To this end, compensation data may be stored in the storage device 150. In one aspect, the compensation data stored in the storage device 150 may be compensation data for compensating degradation of the OLED or a driving transistor of each sub-pixel SP. In this case, the compensation data may be initial compensation data, or real-time compensation data obtained by updating the initial compensation data based on sensing data acquired by a sensing circuit included in the data driving circuit 130.

In another aspect, the compensation data stored in the storage device 150 may be compensation data for compensating variations in characteristics such as a threshold voltage Vth and mobility k of the driving transistor, which are caused by process variations in fabrication of a transistor substrate.

In the above aspects, the storage device 150 may be a flash memory.

In particular, when loading compensation data from the storage device 150 at turn-on of the OLED display panel driving apparatus 115, the timing controller 140 according to the present disclosure may load only first data, which is portion of the compensation data, rather than loading all of the compensation data. Accordingly, an overall booting time of the OLED display device 100 can be reduced.

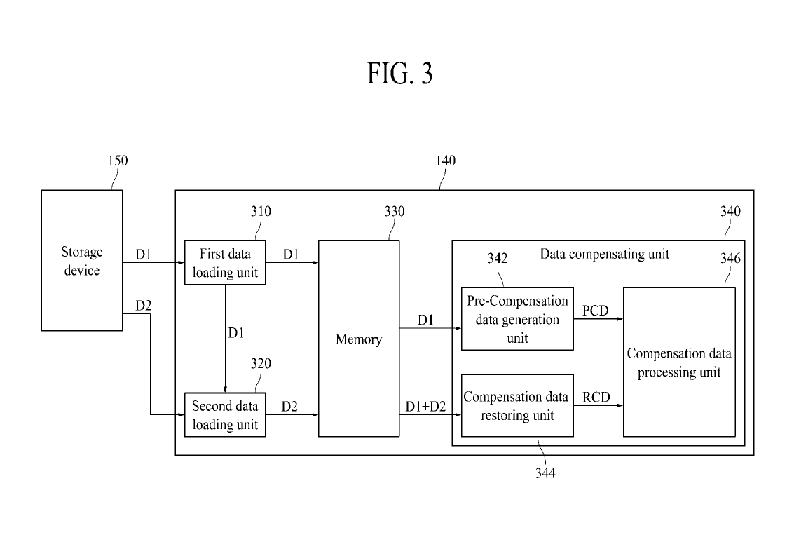

Hereinafter, a configuration of the timing controller according to an aspect of the present disclosure will be described in more detail with reference to FIG. 3.

FIG. 3 is a block diagram schematically showing a configuration of a timing controller illustrated in FIG. 2.

As illustrated in FIG. 3, the timing controller 140 according to an aspect of the present disclosure includes a first data loading unit 310, a second data loading unit 320, a memory 330, and a data compensating unit 340. The data compensating unit 340 may include a pre-compensation data generation unit 342, a compensation data restoring unit 344, and a compensation data processing unit 346.

The first data loading unit 310 accesses the storage device 150 when the OLED display panel driving apparatus 115 is turned on and loads first data D1, which is a portion of compensation data, from the storage device 150. The reasons why the timing controller 140 according to the present disclosure loads only the first data D1-a portion of the compensation data-using the first data loading unit 310 upon the turn-on of the OLED display panel driving apparatus 115 is as follows.

As the resolution of the OLED display device 100 increases, the volume of the compensation data increases, and thus, when all of the compensation data is loaded, a booting time of the OLED display device 100 is increased due to an increase in loading time of the compensation data. Accordingly, in the present disclosure, in order to reduce a loading time of the compensation data and a booting time of the OLED display device 100, when the OLED display panel 110 is turned on, the timing controller 140 does not load the entire compensation data stored in the storage device 150. Instead, by loading only a portion of the compensation data first, the timing controller 140 compensates the image data DATA using only the loaded portion of the compensation data.

In one aspect, the first data D1 may be Most Significant Bit (MSB) data composed of a predetermined number of bits among the compensation data. For example, when the compensation data is composed of eight bits, the first data loading unit 310 may load four bits from the most significant bit of the compensation data as the first data D1.

In the present disclosure, the reason why the first data loading unit 310 first loads only MSB data composed of a predetermined number of bits among the compensation data is that the MSB data has a greater influence on compensation of the image data DATA than Least Significant Bit (LSB) data, and thus, by first loading the MSB data and compensating the image data DATA using the MSB data, degradation of image quality that may occur when compensation is performed using only a portion of the compensation data can be minimized.

In one aspect, the first data loading unit 310 may store the first data D1 loaded from the storage device 150 in the memory 330, and may also deliver the first data D1 to the second data loading unit 320.

The second data loading unit 320 accesses the storage device 150 and loads second data D2, which is a remaining portion of the compensation data, from the storage device 150. That is, the second data loading unit 320 loads, as the second data D2, the remaining portion of the compensation data stored in the storage device 150, excluding the first data D1 loaded by the first data loading unit 310. To this end, the second data loading unit 320 receives the first data D1, which has been first loaded by the first data loading unit 310, from the first data loading unit 310, thereby being able to specify a portion of the compensation data that the second data loading unit 320 has to load.

In one aspect, when the first data D1 is MSB data composed of a predetermined number of bits, the second data D2 may be LSB data of the compensation data excluding the MSB data. The second data loading unit 320 may store the second data D2 loaded from the storage device 150 in the memory 330.

Meanwhile, in the above aspect, the second data loading unit 320 may access the storage device 150 and load the second data D2 from the storage device 150 while image data DATA compensated using the first data D1 is being displayed. As such, according to the present disclosure, since the second data D2 is loaded while the image data DATA compensated using the previously loaded first data D1 is being displayed, it is possible to maximize a reduction in booting time of the OLED display device 100.

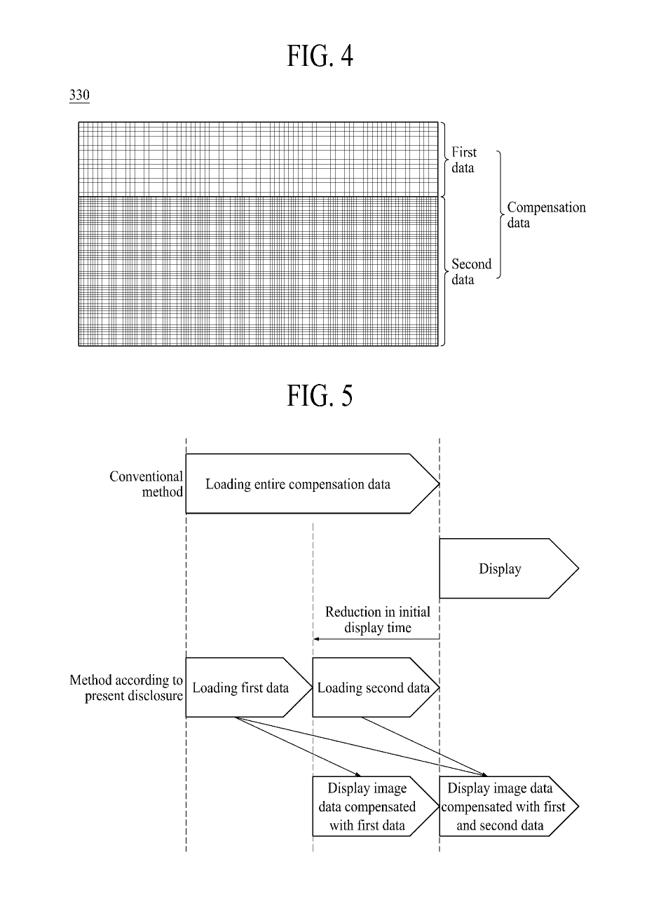

The first data D1 loaded by the first data loading unit 310 and the second data D2 loaded by the second data loading unit 320 are recorded in the memory 330. In one aspect, the first data D1 and the second data D2 may be separately recorded in the memory 330 in a form as illustrated in FIG. 4, so that the data compensating unit 340 may compensate the image data DATA using only the first data D1 or may compensate the image data DATA using both the first data D1 and the second data D2.

In the above-described aspect, the timing controller 140 has been described as including the memory 330, but this is merely exemplary, and in another aspect, the timing controller 140 may not include the memory 330, and the first data loading unit 310 may directly deliver the first data D1 to the data compensating unit 340, and the second data loading unit 320 may directly deliver the second data D2 or the first and second data D1 and D2 to the data compensating unit 340.

Referring back to FIG. 3, the data compensating unit 340 compensates the image data DATA using the first data D1 during a first period including n frames after turn-on of the OLED display panel driving apparatus 115, and compensates the image data DATA using the first data D1 and the second data D2 during a second period (i.e., a period after n frames) after the first period.

To this end, the data compensating unit 340 according to the present disclosure includes the pre-compensation data generation unit 342, the compensation data restoring unit 344, and the compensation data processing unit 346, as illustrated in FIG. 3.

The pre-compensation data generation unit 342 generates pre-compensation data PCD using the first data stored in the memory 330. In one aspect, the pre-compensation data generation unit 342 may generate the pre-compensation data by combining the first data D1 with a number of zero-padded bits corresponding to the number of bits of the second data D2. For example, when the compensation data is composed of eight bits and the first data D1 is MSB data composed of four bits, the pre-compensation data generation unit 342 may generate pre-compensation data PCD composed of eight bits by adding four zeros to the four bits corresponding to the MSB data.

The compensation data restoring unit 344 may generate restored compensation data RCD by restoring compensation data using the first data D1 and the second data D2. In one aspect, the compensation data restoring unit 344 may generate the restored compensation data RCD by combining bit values of the first data D1 with bit values corresponding to the second data D2. For example, when the compensation data is composed of eight bits and the second data D2 is LSB data composed of four bits, the compensation data restoring unit 344 may generate restored compensation data RCD composed of eight bits by combining four bit values corresponding to the LSB data with four bit values corresponding to the MSB data.

The compensation data processing unit 346 compensates and displays the image data DATA using the pre-compensation data generated by the pre-compensation data generation unit 342 or compensates and displays the image data DATA using the restored compensation data RCD generated by the compensation data restoring unit 344.

In one aspect, the compensation data processing unit 346 may compensate the image data DATA using the pre-compensation data PCD during the first period after turn-on of the OLED display panel driving apparatus 115 and may compensate the image data DATA using the restored compensation data RCD during the second period.

In particular, as described above, while the compensation data processing unit 346 compensates and displays the image data DATA using the pre-compensation data PCD generated using the first data D1, the second data loading unit 320 loads the second data D2, and the compensation data restoring unit 344 generates the restored compensation data RCD using the first data D1 and the second data D2. Thereafter, the compensation data processing unit 346 compensates and displays the image data DATA using the restored compensation data RCD generated by the compensation data restoring unit 344.

According to the above-described aspect, image data DATA compensated using the pre-compensation data PCD during the first period after turn-on of the OLED display panel driving apparatus 115 may be initial image data including logo data. Image data DATA compensated using the restored compensation data RCD during the second period may be normal image data. Here, the normal image data means actual image data to be output through the OLED display panel 110.

FIG. 5 conceptually the reduction in initial display time achieved by compensation and display of the image data according to the present disclosure, compared to that of the conventional method.

As illustrated in FIG. 5, in the conventional method, since image data DATA is compensated and displayed using all of the compensation data after loading all of the compensation data, the initial display time is lengthened. However, in the present disclosure, during a first period after turn-on of the OLED display panel driving apparatus 115, initial image data compensated with pre-compensation data PCD generated using the first data D1 is displayed and while the initial image data compensated using the pre-compensation data PCD is being displayed, the second data D2 is additionally loaded. Thereafter, normal image data compensated with restored compensation data RCD generated using the first and second data D1 and D2 is displayed, thereby shortening the initial display time.

In addition, according to the present disclosure, initial image data compensated using MSB data is displayed during a period in which initial image data is displayed when the OLED display device 100 is turned on. Then, normal image data compensated using both MSB data and LSB data is displayed during a period in which normal image data is displayed. Accordingly, it is possible to minimize the user’s perception of image quality degradation that may occur during display of the initial image data.

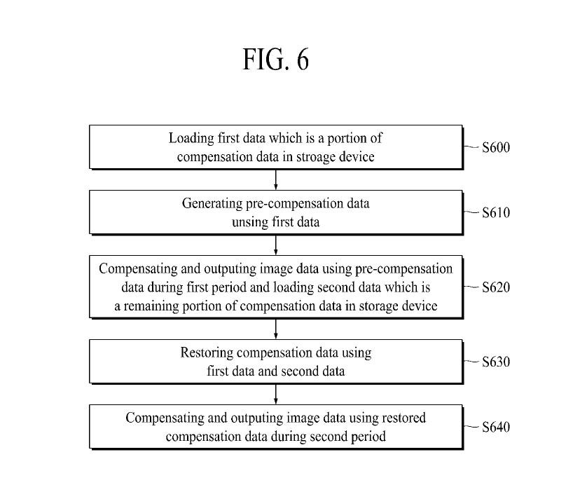

Hereinafter, a method for driving the OLED display panel according to the present disclosure will be described with reference to FIG. 6.

FIG. 6 is a flowchart illustrating a method for driving the OLED display panel according to an aspect of the present disclosure. The method for driving the OLED display panel illustrated in FIG. 6 may be performed by the timing controller illustrated in FIG. 3.

As illustrated in FIG. 6, in step of S600, the timing controller 140 accesses the storage device 150 in which compensation data for compensating sub-pixels is stored and loads first data D1, which is a portion of the compensation data, from the storage device.

In one aspect, the compensation data stored in the storage device 150 may be compensation data for compensating degradation of the OLED or the driving transistor of each sub-pixel SP, and may be initial compensation data or real-time compensation data obtained by updating the initial compensation data based on sensing data acquired by the sensing circuit included in the data driving circuit 130.

In another aspect, the compensation data stored in the storage device 150 may be compensation data for compensating variations in characteristics such as the threshold voltage Vth and mobility k of the driving transistor, which are caused by process variations in fabrication of the transistor substrate.

The reason why the timing controller 140 according to the present disclosure loads only the first data D1, which is a portion of the compensation data, at turn-on of the OLED display panel driving apparatus 115 is as follows.

As the resolution of the OLED display device 100 increases, the volume of the compensation data increases, and thus, when all of the compensation data is loaded, a booting time of the OLED display device 100 is increased due to an increase in loading time of the compensation data. Therefore, in the present disclosure, in order to reduce a loading time of the compensation data and a booting time of the OLED display device 100, when the OLED display panel 110 is turned on, the timing controller 140 first loads only a portion of the compensation data stored in the storage device 150 and compensates image data DATA using only the loaded portion of the compensation data.

In one aspect, in step S600, the timing controller 140 may load, as the first data D1, MSB data composed of a predetermined number of bits from the compensation data stored in the storage device 150. For example, when the compensation data is composed of eight bits, the timing controller 140 may load four bits from the most significant bit among the compensation data as the first data D1.

In the present disclosure, the reason why the timing controller 140 first loads only MSB data composed of a predetermined number of bits among the compensation data is that the MSB data has a greater influence on compensation of the image data DATA than LSB data. Accordingly, by first loading and compensating using the MSB data, degradation of image quality that may occur when compensation is performed using only a portion of the compensation data may be minimized.

Subsequently, in step S610, the timing controller 140 generates pre-compensation data PCD using the first data D1. In one aspect, the timing controller 140 may generate the pre-compensation data PCD by combining the first data D1 loaded in step S600 with a predetermined number of zero-padded bit values. In this case, the predetermined number may correspond to a difference between the number of bits of the compensation data and the number of bits of the first data. For example, when the compensation data is composed of eight bits and the first data D1 is MSB data composed of four bits, the timing controller 140 may generate pre-compensation data PCD composed of eight bits by adding four zeros to the four bits corresponding to the MSB data.

Then, in step S620, the timing controller 140 compensates and displays the image data DATA using the pre-compensation data during a first period including n frames and accesses the storage device 150 to load second data D2, which is a remaining portion of the compensation data stored in the storage device 150. In one aspect, when the first data D1 is MSB data composed of a predetermined number of bits, the second data D2 may be LSB data of the compensation data excluding the MSB data.

As described above, the timing controller 140 may access the storage device 150 and load the second data D2 from the storage device 150 while the image data DATA compensated using the first data D1 is being displayed. Therefore, according to the present disclosure, since the second data D2 is loaded while the image data DATA compensated using the previously loaded first data D1 is being displayed, it is possible to maximize a reduction in booting time of the OLED display device 100.

In one aspect, image data DATA compensated using the first data D1 during the first period may be initial image data including logo data.

Subsequently, in step S640, the timing controller 140 restores compensation data using the first data D1 and second data D2 to generate restored compensation data. In one aspect, the timing controller 140 may generate restored compensation data RCD by combining bit values of the first data D1 with bit values corresponding to the second data D2. For example, when the compensation data is composed of eight bits and the second data D2 is LSB data composed of four bits, the timing controller 140 may generate restored compensation data RCD composed of eight bits by combining four bit values corresponding to the MSB data with four bit values corresponding to the LSB data.

Then, in step S640, the timing controller 140 compensates and outputs the image data DATA using the restored compensation data RCD during a second period after the first period. In one aspect, image data DATA compensated using the restored compensation data RCD during the second period may be normal image data.

As described above, according to the present disclosure, initial image data compensated using MSB data is displayed during a period in which initial image data is displayed when the OLED display device 100 is turned on. Then, normal image data compensated using both MSB data and LSB data is displayed during a period in which normal image data is displayed. Accordingly, it is possible to minimize the user’s perception of image quality degradation that may occur during display of the initial image data.

According to the present disclosure, when the OLED display device is turned on, the timing controller does not load all of the compensation data stored in the storage device but loads only a portion of the compensation data to compensate the image data for n frames, thereby reducing the time required to load the compensation data and thus reducing the booting time of the OLED display device.

Further, according to the present disclosure, when the OLED display device is turned on, since Most Significant Bit(MSB) data among the compensation data is first loaded as a portion of the compensation data and the image data can be compensated using the MSB data, degradation of image quality that may occur due to compensation of image data using only partial compensation data can be minimized.

Furthermore, according to the present disclosure, during a section in which initial image data such as a logo, rather than normal image data, is displayed when the OLED display device is turned on, the initial image data is compensated using the MSB data, and during a section in which normal image data is displayed, Least Significant Bit (LSB) data is additionally loaded and normal image data is compensated using the entire compensation data, whereby deterioration of image quality that may occur during display of the initial image data can be made minimally perceptible to a user.

A person skilled in the art to which the present disclosure pertains will understand that the present disclosure described above may be implemented in other specific forms without changing its technical idea or essential characteristics.

Therefore, it should be understood that the aspects described above are exemplary in all respects and not limiting. The scope of the present disclosure is indicated by the claims described below rather than the detailed description, and all changes or modifications derived from the meaning and scope of the claims and their equivalent concepts should be interpreted as being included in the scope of the present disclosure.

What is claimed is:

1. An OLED display panel driving apparatus comprising:
a storage device in which compensation data for compensating sub-pixels included in an organic light emitting diode (OLED) display panel is stored; and
a timing controller configured to load the compensation data from the storage device and to compensate image data to be output through the sub-pixels,
wherein the timing controller includes:
a first data loading unit configured to load, from the storage device, first data which is a portion of the compensation data,
a second data loading unit configured to load, from the storage device, second data which is a remaining portion of the compensation data; and
a data compensating unit configured to compensate the image data using the first data during a first period including n frames, and to compensate the image data using the first and second data during a second period after the first period,
wherein the second data loading unit is configured to load the second data while image data compensated with the first data is being output.

2. The OLED display panel driving apparatus of claim 1, wherein the data compensating unit includes:
a pre-compensation data generation unit configured to generate pre-compensation data using the first data;
a compensation data restoring unit configured to restore the compensation data using the first data and the second data; and
a compensation data processing unit configured to compensate the image data using the pre-compensation data during the first period and to compensate the image data using the restored compensation data during the second period.

3. The OLED display panel driving apparatus of claim 2, wherein the pre-compensation data generation unit generates the pre-compensation data by combining the first data with a number of zero-padded bits corresponding to the number of bits of the second data,
and the compensation data restoring unit restores the compensation data by combining bit values of the first data with bit values of the second data.

4. The OLED display panel driving apparatus of claim 1, wherein image data compensated using the first data during the first period is initial image data including logo data,
and image data compensated using the first and second data during the second period is normal image data.

5. The OLED display panel driving apparatus of claim 1, wherein the first data is Most Significant Bit (MSB) data composed of a predetermined number of bits among the compensation data, and the second data is Least Significant Bit (LSB) data of the compensation data excluding the MSB data.

6. The OLED display panel driving apparatus of claim 1, wherein the compensation data includes at least one of compensation data for compensating degradation of an organic light emitting diode disposed in the sub-pixel and a driving transistor for driving the organic light emitting diode, and compensation data for compensating variations in characteristics of the driving transistor caused by process variations in fabrication of a transistor substrate.

7. The OLED display panel driving apparatus of claim 1, wherein the storage device is a flash memory.

8. A method for driving an OLED display panel, comprising:
loading, from a storage device in which compensation data for compensating sub-pixels included in the OLED display panel is stored, first data which is a portion of the compensation data;
compensating and outputting image data using the first data during a first period including n frames;
loading, from the storage device, second data which is a remaining portion of the compensation data while image data compensated with the first data is being output; and
compensating and outputting the image data using the first and second data during a second period after the first period.

9. The method of claim 8, further comprising:
generating pre-compensation data by combining the first data with a number of zero-padded bits corresponding to the number of bits of the second data; and
restoring compensation data by combining the second data with the first data,
wherein the image data is compensated using the pre-compensation data during the first period,
and the image data is compensated using the restored compensation data during the second period.

10. The method of claim 8, wherein initial image data including logo data is compensated using the first data and output during the first period,
and normal image data is compensated using the first and second data and output during the second period.

11. The method of claim 8, wherein the first data is MSB data composed of a predetermined number of bits among the compensation data, and the second data is LSB data of the compensation data excluding the MSB data.

12. The method of claim 8, wherein the compensation data includes at least one of compensation data for compensating degradation of an organic light emitting diode disposed in the sub-pixel and a driving transistor for driving the organic light emitting diode, and compensation data for compensating variations in characteristics of the driving transistor caused by process variations in fabrication of a transistor substrate.
